(19) United States
(12) Patent Application Publication
(10) Pub. No.: US 2020/0062470 A1
(43) Pub. Date: Feb. 27, 2020

(54) Dust control lid for feed mixer

(71) Applicant: International Dairy Solutions, LLC, LaFollette, TN (US)

(72) Inventor: David Greene, LaFollette, TN (US)

(21) Appl. No.: 16/545,060

(22) Filed: Aug. 20, 2019

Related U.S. Application Data
(60) Provisional application No. 62/720,512, filed on Aug. 21, 2018.

(51) Int. Cl. B65D 51/32

(52) U.S. Cl. CPC B65D 51/32; A23N 17/007

(57) ABSTRACT

Apparatus for controlling dust exhausted from a container. A lid fits over the opening of a container, such as a feed mixer, that receives a stream of ingredients that carries and/or produces dust. The lid includes a pair of wedge-shaped end sections. The proximal ends of the end sections define a lid through-opening, which is sized to receive ingredients poured into the container. Each of the end sections have a cavity with an open bottom that is contiguous with the inside of the container. Inside the cavity is at least one baffle that extends down toward the container. The baffles are configured to redirect particles entrained in the air pushed inside the container. In one embodiment, at least two of the sides of the lid opening are lined with brushes.

### CROSS-REFERENCE TO RELATED APPLICATIONS

This application claims the benefit of U.S. Provisional Application No. 62/720,512, filed Aug. 21, 2018.

### STATEMENT REGARDING FEDERALLY SPONSORED RESEARCH OR DEVELOPMENT

Not Applicable

### BACKGROUND

### 1. Field of Invention

This invention pertains to a device for reducing dust emitted from containers, such as feed mixers. More particularly, this invention pertains to a lid positioned on top of a container, such as a feed mixer, that controls the release of livestock ration particles by reducing the amount of particles escaping the container during the ingredient pouring and/or mixing process.

### 2. Description of the Related Art

Livestock feed ration is comprised of multiple ingredients that are mixed together. The ingredients include cut and uncut hay, grains, powdered vitamins and minerals, and/or liquids. The ingredients are typically poured into the top of an open mixer and stirred by single or multiple augers, screws, and/or reels. The mixed result is referred to as a Total Mixed Ration (TMR).

During the loading and mixing process, a great amount of dust escapes from the mixer. The escaping dust creates respiratory health hazards for workers. In addition, some of the concentrated vitamin and mineral powder are toxic when inhaled or absorbed through the skin in large amounts. Furthermore, the escaping dust is flammable and presents a fire and/or explosion hazard. Moreover, the escaping dust is an environmental hazard and nuisance to surrounding properties.

Smaller ingredient particles, such as the vitamin and mineral powders, are more likely to be lost through escaping dust. Thus, mixing that involves escaping dust will result in the Total Mixed Ration having an improper ratio of ingredients, resulting in less healthy and productive livestock. The smaller particles also tend to be the more expensive ingredients, resulting in shrink loss of thousands of dollars per year. Changing the order of loading ingredients will only partially eliminate the amount of escaping dust. Dust collection systems can be installed to capture dust, but they are often expensive and require high maintenance.

The operator of a dispenser may have difficulty viewing the augers, screws, or reels and properly targeting the ingredients into the center of the mixer between the augers, screws, or reels for optimal mixing. When feed is not loaded in the center of the mixer, or if the mixer is overloaded with ingredients, the ration will not be mixed properly and livestock will not perform as expected. Overfilling a mixer with ingredients is also a common problem. When the mixers are over-filled, they do not mix properly and livestock will not perform as expected.

FIG. 1 illustrates a symbolic view of a prior art system. The illustrated container is a conventional feed mixer 102 receiving ingredients 104 to create a Total Mixed Ration (TMR). The ingredients 104 are dumped or poured into the mixer 102, such as from a dispenser 126. The ingredients 104 entering the mixer 102 produce clouds of dust 124 that are exhausted or emitted from the mixer 102. The clouds of dust 124 are made of particles 104-A that are produced and/or carried by the ingredients 104 as the ingredients 104 flow into the mixer 102. The movement of the ingredients 104 into the mixer 102 causes an air-flow 116 in the mixer 102 that causes the particles 104-A to circulate in the mixer 102 and exit through the opening 122, thereby forming dust clouds 124. These dust clouds 124 result in lost money 150 through shrink and various other adverse effects.

Conventional feed mixers 102 are containers that have various configurations, including mixers incorporated in portable wagons and mixers with a permanent, fixed mount. Feed mixers vary in shape and size. Some have walls 114 that are planar plates, others have walls 114 with arcuate surfaces, such as cylindrical or curved surfaces. Generally, feed mixers receive ingredients 104 and include one or more mixing augers that mix those ingredients 104. The illustrated vertical feed mixer 102 has an oblong opening 122 at the mixer top or rim 120. The illustrated mixer 102 has distal ends 130. The mixer 102 includes walls 114 that extend upward from the base or floor 118 to the rim 120. Generally, the walls 114 are sheet metal or plate that is formed to the desired contour of the mixer 102. The top rim 120 is typically reinforced, such as with tube steel, pipe, or additional plates. The reinforcement adds rigidity to the walls 114.

The ingredients 104 poured into the mixer 102 often include cut or uncut hay, grains, minerals, vitamins, and liquids. Typically, the ingredients 104 are poured in individually. In some processes, the ingredients 102 are poured into the mixer 102 by way of a dispenser 126. Various dispensers 126 include a loader, such as a shovel tractor or a conduit or duct in which the ingredients 104 move, such as by gravity feed or by an auger.

The ingredients 104 often include particles 104-A that are light enough to be carried in the air-flow 116. Also, the ingredients 104 often are subject to handling, such as by pouring and mixing, in the mixer 102 that results in creating and/or releasing particles 104-A that are light enough to be carried in the air-flow 116. These particles 104-A have a tendency to move with the air flow 116 up the walls 114 of the mixer 100, out of the mixer opening 122, and create clouds of dust 124.

The particles 104-A that exit the mixer 102 in the dust clouds 124 represent lost ingredients 104, which results in improperly fed livestock 146 because of an inaccurate Total Mixed Ration. The various ingredients 104 in the feed are often lost in dust clouds 124 in quantities not proportional to the original ingredients 104. For example, the vitamins and minerals in the ingredients 104 tend to be lighter than the grains and more subject to loss through emitted dust clouds 124. As a result, the ratio of the ingredients 104 in the final Total Mixed Ration often differ from the predetermined, intended ratio of the ingredients 104 added into the mixer 102.

When the mixer 102 is in an enclosed structure such as a barn, the escaping dust 124 presents a fire and/or explosion hazard 148. Feed mix dust in an enclosed structure satisfies the five elements of dust explosion: dust, confinement (the enclosed structure), dispersion (the escaping cloud), oxidant (the air proximate the dust), and ignition (e.g., hot or sparking machinery or a lit cigarette).

If the mixer 102 is not in an enclosed structure, the escaping dust 124 presents environmental hazards 142, 144 and nuisances. In large livestock operations, the escaping dust 124 affects the air quality of surrounding properties and neighborhoods. The environmental hazards 142 include health hazards for workers, including inflammation of the airways, rhinitis, coughing and breathing difficulties, asthma, chronic bronchitis, chronic obstructive pulmonary disease, allergic alveolitis, respiratory cancers, organic dust toxic syndrome, eye irritation, and absorption of toxins through the lungs and airways. The dust 124 that is airborne includes inhalable dust and respirable dust. Respirable dust is capable of penetrating as far as the pulmonary alveoli, causing both local phenomena and resulting in the absorption of any toxic agents contained in the dust. In the animal feed industry, approximately 40% of the total inhalable dust comprises respirable dust. The dust 124 that is airborne includes feed additives. Feed additives include trace element metals, nutritional additives, and zootechnical additives. As an example, in the case of the additive of manganese, which can have toxic effects when absorbed, almost 60% of the manganese dust 124 is classified as respirable. Another environmental hazard 144 is the contamination of open water that can affect fish and/or aquatic animals and plants. Many of the ingredients 104 in the escaping dust 124 are toxic when concentrated and those ingredients 104 can contaminate nearby water biomes and reserves.

### BRIEF SUMMARY

According to one embodiment of the present invention, a lid for dust control of a container, such as a feed mixer, is provided. The lid includes a wall whose bottom edge rests flush on the entire top rim of a container. The lid has an opening in the middle that is of sufficient size to allow ingredients to be poured into the container or mixer. The lid is comprised of a pair of end sections. The top plate of each of the sections slopes downward toward the center opening in the middle of the lid. Air currents that would ordinarily carry ingredient dust upward over the sides of the container are redirected by the downward-sloping sections back into the center of the mixer, allowing the dust particles to settle back to the bottom of the mixer once the currents have dissipated.

The end sections include vertical baffles that redirect the air currents flowing along the lid undersides. The baffles force the air currents and accompanying dust downward into the mixer before the currents and particles reach the opening in the center of the lid. Thus, the air currents are redirected and/or dissipated before the currents are able to carry the dust particles out of the mixer.

In one embodiment, the lid includes a first end section and a second end section. The end sections act as caps on opposing ends of the mixer. The first and second end sections are symmetrical. In other embodiments, for example where the ends of the mixer are not symmetrical, the sections also are not symmetrical. The first and second end sections are each shaped like a wedge with a blunted knife edge and an open bottom.

The first and second end sections each include a wall contiguous with a ceiling or top plate. The wall is vertical and has a bottom edge that rests flush on the mixer. Each wall is highest at its respective far end of the mixer. The sections each include a top plate that is flat and slopes downward toward the opening in the center of the lid. The top plate is lowest at the opening in the center of the device.

The first and second end sections each include a first, or outer, baffle and a second, or inner, baffle that extend from their respective top plate undersides. The first and second baffles are planar and parallel. The first and second baffles are rectangular. The first baffle extends vertically down from the respective section's top plate to the respective bottom edge of the section. The second baffle extends vertically down from the respective section's top plate to the respective bottom edge of the section. In one embodiment, both ends of the first and second baffles are essentially flush with their respective curved section wall, such that the respective underside is divided into three volumes. The second baffle is between the first baffle and the lid opening.

Side members extend between the opposing end sections. The side members each include an outer sheet or wall whose bottom edge rests flush on the mixer. In one embodiment, the side members are joined at their ends to the two end sections. The side members are of equal length. The side pieces each include a top sheet that is contiguous with its respective wall. Each top sheet is flat and planar. Each top sheet is highest where it joins the wall and slopes downward to the opening in the center of the lid.

### BRIEF DESCRIPTION OF THE SEVERAL VIEWS OF THE DRAWINGS

The above-mentioned features will become more clearly understood from the following detailed description read together with the drawings in which:

FIG. 1 is a symbolic view of a conventional feed mixer during a feed loading process.

FIG. 2 is a symbolic view of one embodiment of a lid on top of a feed mixer during a feed loading process.

FIG. 3 is a side view of one embodiment of the lid.

FIG. 4 is a top view of one embodiment of the lid shown in FIG. 3.

FIG. 5 is a cross-sectional view of an end section of the lid shown in FIG. 3.

FIG. 6 is a cross-sectional view of a first side piece of the lid shown in FIG. 3.

FIG. 7 is a cross-sectional view of a second side piece of the lid shown in FIG. 3.

FIG. 8 is a top view of another embodiment of a lid.

FIG. 9 is a partial cross-sectional view of an end section of the lid shown in FIG. 8.

FIG. 10 is a cross-sectional view of a first side piece of the lid shown in FIG. 8.

### DETAILED DESCRIPTION

An apparatus for dust control for a containment device is disclosed. The dust control device is generally indicated as a lid 100, with particular embodiments and variations shown in the figures and described below having an alphabetic suffix, for example, 100-A and 100-B. Various components are illustrated both generically and specifically in the figures and in the following description. For example, the side members 202 are discussed individually and separately to ensure clarity when describing the configuration of each member 202-1, 202-2, 202′. The side members 202, when referred to collectively, are referenced without a suffix or prime.

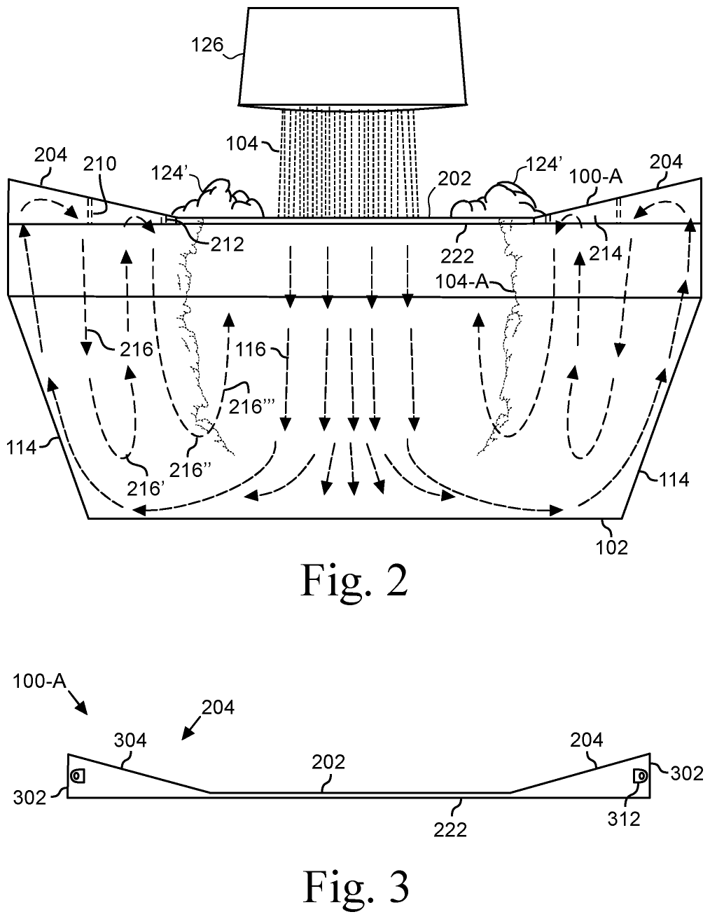

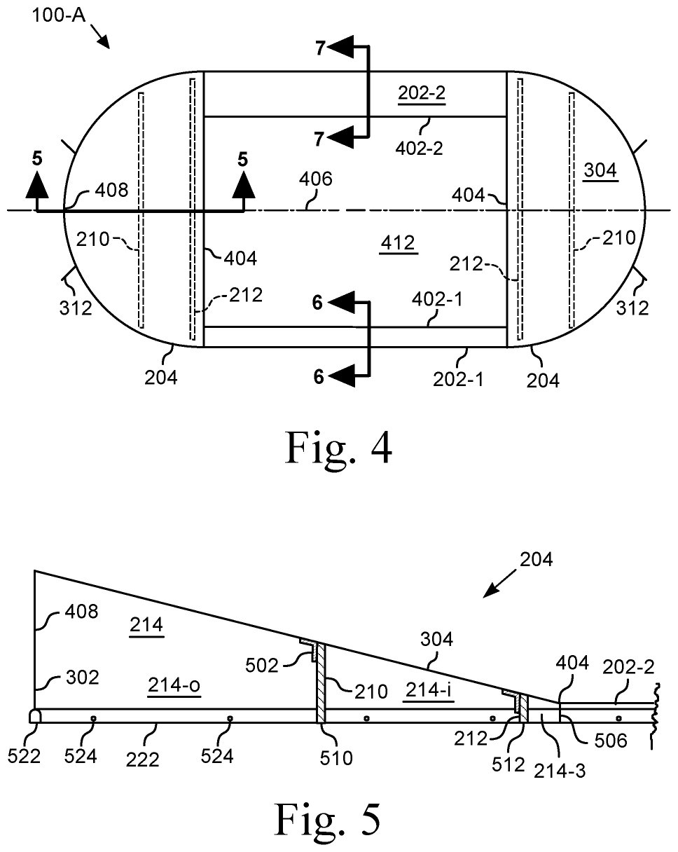

FIG. 2 illustrates symbolic view of a lid 100 on the top rim 120 of the mixer 102 with the mixer 102 receiving the ingredients 104. FIG. 3 illustrates a side view of one embodiment of the lid 100-A. FIG. 4 illustrates a top view of the lid 100-A. The illustrated embodiment of the lid 100-A has an oblong shape, as seen from the top, and has a longitudinal axis 406 that is coplanar with a longitudinal axis of the mixer 102. The lid 100-A includes a pair of end sections 204 connected together with a pair of side members 202-1, 202-2. The end sections 204 and the pair of side pieces, or members, 202-1, 202-2 define a lid opening 412 through which the ingredients 104 pass into the mixer 102.

The lid 100 is described herein in conjunction with a feed mixer 102 for illustrative purposes. A person skilled in the art will recognize that the lid 100 can be used on various types of containers, bins, and/or receptacles that receive dust laden or dust producing contents through an opening without departing from the spirit and scope of the present invention.

The bottom 222 of the lid 100 mates with the lip or rim 120 of the feed mixer 102. In the illustrated embodiment, the opening 122 of the feed mixer 102 has an oblong shape and the configuration of the lid 100-A has a corresponding shape such that the lid 100-A mates to the mixer opening 122 with a sealing connection. That is, the lid 100 is sealed to the mixer lip or rim 120 in such a way as to prevent or minimize escape of the dust cloud 124 between the lid 100 and the mixer rim 120. The end sections 204 each have a distal end 408 that are positioned proximate the distal ends 130 of the mixer 102. In one embodiment, the lid 100 is releasably attached to the mixer 102. In another embodiment, the lid 100 is integral with, or permanently a part of, the mixer 102. For example, in one such embodiment, the section wall 302 is a continuation of the mixer sidewall 114.

In the illustrated embodiment, the end sections 204 are reflectively symmetrical. The end sections 204 are configured to conform to the portion of the mixer 102 on which the sections 204 fit. Each section 204 of the lid 100-A defines a cavity 214 that is bounded by a top plate 304 and a section wall 302. The top plate 304 has a higher elevation at the distal end of the lid 100-A with the top plate 304 sloping downward toward the lid opening 412. The section wall 302 encircles the outer periphery of the top plate 304 and fills the distance between the edge of the top plate 304 and the rim 120 of the mixer 102. The cavity 214 is open on the bottom 222 where the lid 100-A mates with the mixer 102. In various embodiments, the outer surface of the section wall 302 includes various lifting and securing tabs or points 312. Such lifting tabs and/or points 312 are useful for handling the lid 100 to position it on a mixer 102. Such securing tabs and/or points 312 are also useful for securing the lid 100 to the mixer 102.

In the illustrated embodiment, each section 204 includes an outer, or first, baffle 210 and an inner, or second, baffle 212. In another embodiment, each section 204 includes only an outer, or first, baffle 210. Both baffles 210, 212 extend downward toward the inside of the mixer 102. In one embodiment, both baffles 210, 212 have a distal end 510, 512 that is coplanar with the bottom 222 of the lid 100-A. The baffles 210, 212 extend across the top plate 304 between the section wall 302 on each side of the top plate 304. In one embodiment, the baffles 210, 212 extend to the section walls 302. In other embodiments, there is a gap between the ends of the baffles 210, 212 and the section walls 302. In some embodiments, such was when the mixer 102 has only one or two mixing augers and the mixer opening 122 is less oblong than the illustrated embodiment, only the outer baffle 210 is present. For cases where the mixer 102 has more than two augers or the mixer opening 122 is elongated, both the outer baffle 210 and the inner baffle 212 are present.

The baffles 210, 212 are made of a material sufficiently rigid to withstand air currents 116′, 216 created by the loading of ingredients 102. That is, the baffles 210, 212 are sufficiently rigid to avoid or have minimal deformation during normal operation of the feed mixer 102, such as when receiving and mixing ingredients 104. In one embodiment, the baffles 210, 212 are made of steel or other metal. In another embodiment, the baffles 210, 212 are made of a rubber or polymer material. In yet another embodiment, the baffles 210, 212 have a metal portion and a polymer portion where the metal portion is rigid and the polymer portion is resilient.

The pair of side members 202-1, 202-2 extend between the opposing end sections 204. In one embodiment, the ends of the side members 202 are attached to the end sections 204. In another embodiment, the side members 202 are secured to the walls 114 of the mixer 102. The inside edges 402-1, 402-2 of the side members 202-1, 202-2 and the inside edges 404 of the end sections 204 define the lid opening 412. In the illustrated embodiment, one side member 202-2 is wider than the other side member 200-1. In such an embodiment, the wider side member 202-2 serves to ensure that the ingredients 104 being poured into the mixer 102 are spaced away from the corresponding side wall 114 of the mixer 102. In another embodiment, the end sections 204 are attached to the mixer 102 without a pair of side members 202-1, 202-2. In such an embodiment, the opening 412 is defined by the ends or edges 404 of the end sections 204 and the rim 120 of the mixer 102 between the edges 404.

In one embodiment, the lid opening 412 is sized to have an area relative to the cross-sectional area of the stream of ingredients 104 as they pass through the lid opening 412 where the velocity of the air flow exhausting the feed mixer 102 is such that the size of the dust cloud 124′ exhausted through the lid opening 412 is minimized. In one such embodiment, the lid opening 412 is sized to have an area that is approximately two to three-and-one-half times the cross-sectional area of the stream of ingredients 104 as they pass through the lid opening 412.

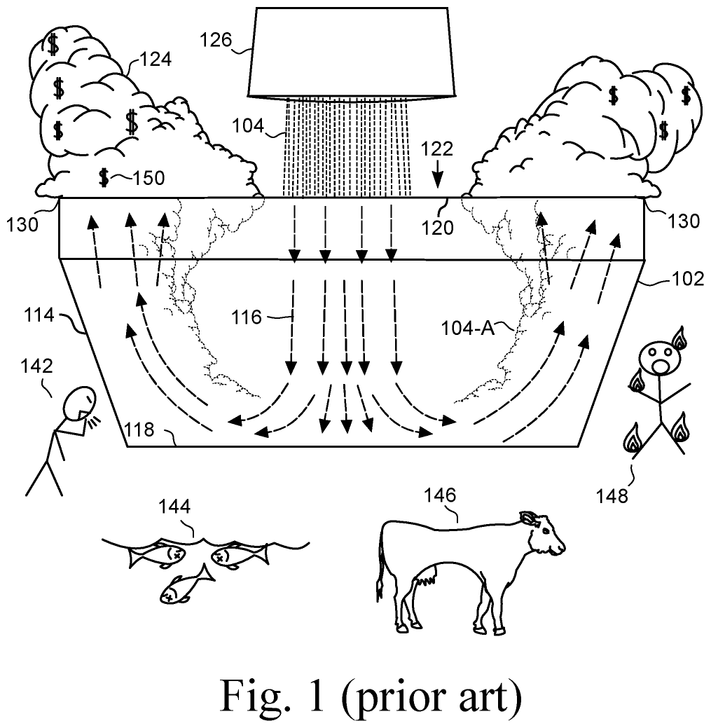

FIG. 2 illustrates the dust clouds 124′ as being reduced in size compared to the dust clouds 124 of the conventional mixer 102 without the lid 100-A illustrated in FIG. 1. The movement of the ingredients 104 through the lid 100-A into the mixer 102 causes an air-flow 116 in the mixer 102 that causes the particles 104-A to circulate in the mixer 102. The air-flow 116 of the particles 104-A follows the contours of the mixer walls 114 until the air-flow 116 encounters the end sections 204 of the lid 100-A. The air-flow 116 is deflected downward 216 after encountering the outer, or first, baffle 210. The deflected air-flow 216 circulates in the mixer 102 where it is redirected as an upward air-flow 216′. The upward air-flow 216′ is deflected downward 216″ after encountering the inner, or second, baffle 210. The twice-deflected air-flow 216″ circulates in the mixer 102 where it is redirected as an upward air-flow 216′″, with some of the particles 104-A carried by the upward air-flow 216′″ exiting through the lid opening 412 as dust clouds 124′.

FIG. 5 illustrates a cross-sectional view of an end section 204 of the lid 100-A. The end section 204 includes a vertical wall 302 that encloses the cavity 214 between the bottom 222 of the end section 204 and the top plate 304. The end section 204 has a wedge shape, tapering down toward the opening 412 in the lid 100-A. In the illustrated embodiment, the bottom 222 of the end section 204 is open to the inside of the feed mixer 102. The bottom 222 is defined by the distal or lower edge of the wall 302 and is configured to mate with the top edge or rim 120 of the mixer 102. In one embodiment, the end sections 204 are integral or permanently attached to the top edge 120 of the mixer opening 122, thereby enclosing that portion of the mixer 102 covered by the end section 204.

In the illustrated embodiment, the outer baffle 210 is positioned medially between the distal 408 end and the inside edge 404 of the end section 204. The inner baffle 212 is positioned proximate the inside edge 404 of the end section 204.

In the illustrated embodiment, the baffles 210, 212 are attached to the top plate 304 with a support member 502, such as angle iron. In this way the baffles 210, 212 present an unimpeded surface exposed to the air-flows 216, 216′, 216″. In the illustrated embodiment, each end section 204 has two baffles 210, 212. In one embodiment, both baffles 210, 212 have a distal end 510, 512 that is coplanar with the bottom 222 of the lid 100-A. In another embodiment, the distal end 510 of the outer baffle 210 does not extend downward as far as the distal end 512 of the inner baffle 212. In another embodiment, the end section 204 has only an outer baffle 210. Such an embodiment is suitable for when the mixer 102 has two or fewer mixing augers.

In the illustrated embodiment, the end section 204 has an edge 404 adjacent the lid opening 412. The edge 404 defines a boundary between the top plate 304 and an inside section wall 506. The inside section wall 506 separates the cavity 214 from the lid opening 412. The inside section wall 506 is a continuation of the end section vertical wall 302 that surrounds the outer periphery of the top plate 304. In the illustrated embodiment, both the bottom of section wall 302 and the bottom of the inside section wall 506 are coplanar with the lid bottom 222.

The end section cavity 214 is divided into an outer cavity 214-o defined by the distal end 408 of the end section 204 and the outer baffle 210. The end section cavity 214 is divided into an inner cavity 214-i defined by the space between the outer baffle 210 and the inner baffle 212. The end section cavity 214 is divided into a third cavity 214-3 defined by the space between the inner baffle 212 and the inside section wall 506.

The bottom 222 of the lid 100 includes an attachment flange 522 that mates with the top rim 120 of the mixer 102. Each attachment flange 522 is configured to mate to a particular type or style of mixer 102. The top rim 120 of mixers 102 varies based on the manufacturer. The attachment flange 522 of the lid 100 is attached to the top rim 120 of the mixer 102. In this way, the lid 100 provides additional structural rigidity to the walls 114 of the mixer 102. The additional rigidity provided by the lid 120 aids in ensuring proper mixing of the ingredients 104 in the mixer 102 because, when the walls 114 flex, even slightly, the consistency of the mixed ingredients 104 varies enough to effect the efficacy of the mixed ingredients 104. With the attachment flange 522 securely attached to the top rim 120 of the mixer 102, the walls 114 of the mixer 102 do not flex when the ingredients 104 are mixed, thereby ensuring better consistency and more uniformity in the distribution of the mixed ingredients 104.

In the embodiment illustrated in FIG. 5, the attachment flange 522 is a U-shaped channel with the open end at the bottom sized and dimensioned to fit over a pipe or other member that is at the top rim 120 of the mixer 102. Mounting holes 524 are provided to allow bolts or other fasteners to be inserted for securing the lid 100 to the mixer 102. In some embodiments, the mounting holes 524 are slots or elongated openings that better allow for manufacturing tolerances in the mixer 102. The attachment flange 522 at the bottom 222 of the lid 100 varies depending upon the construction of the top rim 120 of the mating mixer 102. For example, the top rim 120 of some mixers 102 include an angled plate, while other mixers 102 include a reinforcing tube steel structure. In such examples, the attachment flange 522 is a plate or other structure configured to mate with the top rim 120 of the mixer 102.

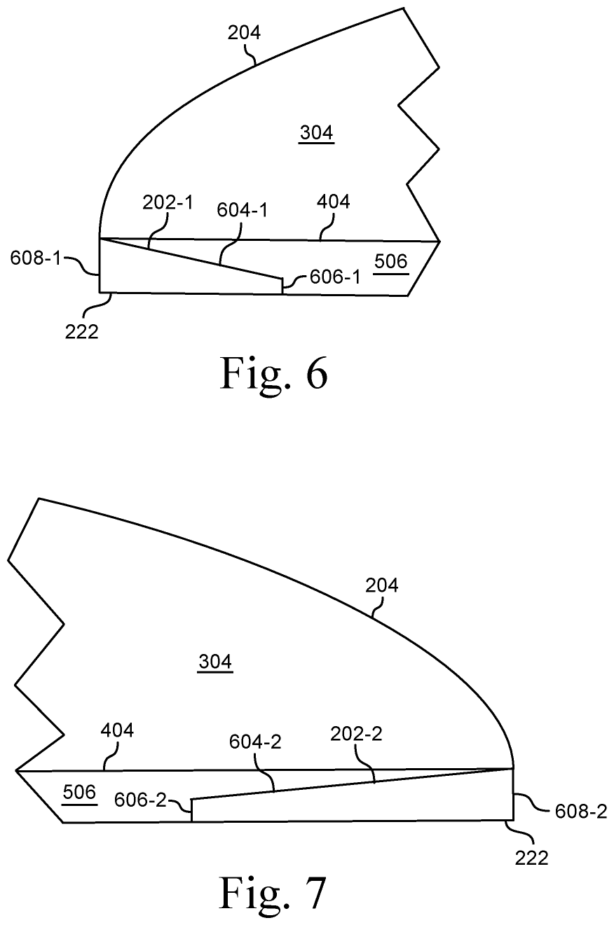

FIG. 6 illustrates a cross-sectional view of a first side piece, or member, 202-1 of the lid 100-A. FIG. 7 illustrates a cross-sectional view of a second side piece, or member, 202-2 of the lid 100-A. The side members 202 connect the pair of end sections 204 while defining the lid opening 412 to be smaller than the space between the mixer walls 114.

Each side member 202-1, 202-2 has a top sheet 604-1, 604-2, an outer sheet 608-1, 608-2, and an inside lip 606-1, 606-2. The top sheet 604 extends from the outside of the lid 100-A to the inside lip 606. The outer sheet 608 is a vertical, planar sheet. The outer sheet 608 has a lower edge that is coplanar with the lid bottom 222 of the lid 100-A and is configured to mate with the top edge or rim 120 if the mixer 102. The inside lip 606 is a vertical, planar sheet. Each one of the inside lips 606 defines one side of the lid opening 412. In the illustrated embodiment, the bottom of the inside lip 606 is coplanar with the lid bottom 222. The top sheet 604 has a sloping surface that allows any ingredients 104 that land on the sheet 604 to slide into the lid opening 412. In one embodiment, the side members 202 are formed with an open bottom. In another embodiment, the side members 202 have a box or tube configuration such that the side members 202 are enclosed along their length.

The end section 204 has an edge 404 where the top plate 304 joins the inside section wall 506. Each one of the inside section walls 506 defines one side of the lid opening 412.

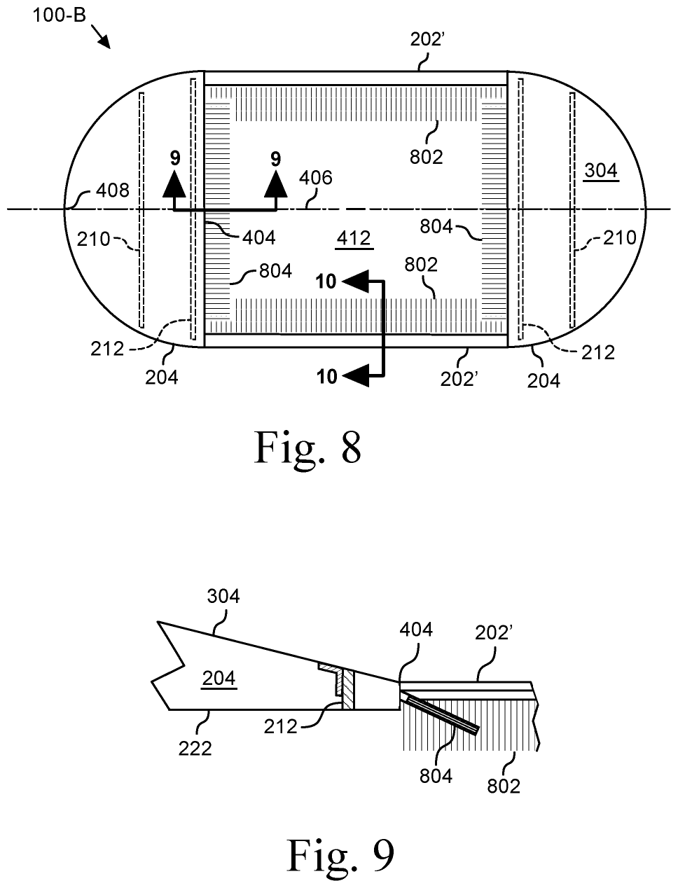

FIG. 8 illustrates a top view of another embodiment of a lid 100-B. The lid 100-B has brushes 802, 804 extending from the side members 202′ and end sections 204, respectively, into the lid opening 412. The pair of end sections 204 of the illustrated embodiment of the lid 100-B are substantially the same as the pair of end sections 204 of the embodiment of the lid 100-B illustrated in FIG. 2-7. The side members 202′ of the illustrated embodiment differ in that the pair of side members 202′ have substantially the same configuration and do not extend as far toward the center of the mixer opening 122 as the side members 202 illustrated in FIGS. 4-7.

A side member brush 802 extends from the face of the inside lip 606′ of each one of the two side members 202′ toward the center of the lid opening 412. An end section brush 804 extends from the inside edge or side 404 of the end sections 204 toward the center of the lid opening 412. In the illustrated embodiment, the end section brushes 804 are attached to the section wall 506 of each end section 204. The brushes 802, 804 have bristles that are flexible and resilient enough and have a spacing between the bristles that allow passage of any ingredients 104 that engage the brushes 802, 804, while being stiff enough to impede the flow of particles 124′ from escaping the mixer 102. In one embodiment, the side member brushes 802 extend further into the opening 412 than the end section brushes 804. For example, the brushes 802 extending from the side members 202′ extend twelve inches into the opening 412 and the brushes 804 extending from the end members 204 extend eight inches into the opening 412.

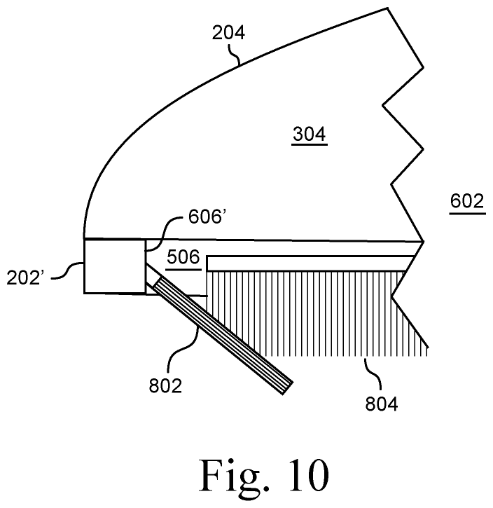

FIG. 9 illustrates a partial cross-sectional view of an end section 204 of the lid 100-B showing the brushes 802, 804 extending into the lid opening 412. FIG. 10 illustrates a cross-sectional view of a first side piece of the lid 100-B showing the brushes 802, 804 extending into the lid opening 412. In the illustrated embodiment, the brushes 802, 804 extend downward such that the end of the brushes 802, 804 extend through the mixer opening 122 into the mixer 102.

FIG. 9 illustrates the end section brush 804 extending away from the end section 204 and downward toward the mixer 102. In one embodiment, the brush 804 is positioned at a 25 degree angle down from the plane defined by the bottom 222 of the lid 100-B. In the illustrated embodiment, the end section brush 804 does not extend into the mixer 102 as far as the side member brush 802.

FIG. 10 illustrates the side member brush 802 extending away from the side member 202′ and downward toward the mixer 102. In one embodiment, the brush 802 is positioned at a 25 degree angle down from the plane defined by the bottom 222 of the lid 100-B. In the illustrated embodiment, the end section brush 804 does not extend into the mixer 102 as far as the side member brush 802.

The dust control lid 100 includes various functions. The function of redirecting the air flow 116 containing particles 104 is implemented, in one embodiment, by the end sections 204 as illustrated in FIG. 2. The end sections 204 each have a cavity 214, at least one baffle 210, 212, and a wedge-shape sloping downward toward the opening 412.

The function of deflecting the air flow 116 containing particles 104 downwards is implemented, in one embodiment, by the baffle 210 in each end section 204, such as illustrated in FIG. 2.

The function of minimizing the size of the opening 412 without restricting the inflow of the feed 104 that is poured into the feed mixer 102 is implemented, in one embodiment, by the brushes 802, 804 extending inward into the opening 412 as illustrated in FIGS. 8, 9, and 10. The feed 104 entering the opening 412 is not restricted by the brushes 802, 804 and the flow of particles 124′ is impeded from escaping the mixer 102 by the brushes 802, 804 protruding into the opening 412.

The function of impeding the impede the flow of particles 124′ from escaping the mixer 102 is implemented, in one embodiment, by brushes 802, 804 protruding into the opening 412 such as illustrated in FIGS. 8-10. The brushes 802, 804 restrict the air flow and air currents 216 while allowing the feed 104 to pass through into the feed mixer 102 without restriction.

The function of directing feed 104 into the feed mixer 102 is implemented, in one embodiment, by the wedge-shaped end sections 204 that have a top surface 304 that slopes downward toward the opening 412, such as illustrated in FIGS. 2, 3, 5-7, and 9-10. The wedge-shape of the end sections 204 encourages any feed 104 falling thereon to move toward and into the opening 412 and into the feed mixer 102.

From the foregoing description, it will be recognized by those skilled in the art that a dust control lid 100 has been provided. In various embodiments, the dust control lid 100 is configured to mate with the open top of a feed mixer 102. The lid 100 includes an opening 412 defined by the end sections 204 and the side members 202. The opening 412 is sized to accommodate the feed 104 that is poured into the feed mixer 102. In one embodiment, the lid 100-B has an opening 412 with inward facing brushes 802, 804.

The dust control lid 100 includes features that individually and together aid in minimizing and/or preventing dust clouds 124′ from escaping the mixer 102 when ingredients 104 are dumped into or added to the mixer 102. One feature of the dust control lid 100 is the wedge-shaped end 204 that has a top panel or plate 304 that slopes downward toward the opening 412. In this way any ingredients 104 that land on the end piece 204 will tend to fall into the opening 412.

Another feature of the dust control lid 100 is that the opening 412 defined by the inboard end or edges 404 reduces the size of the opening 122 of a conventional mixer 102 without the lid 100. In this way there is less open space for the ingredients 104 to escape in a dust cloud 124′. In one embodiment of this feature, brushes 802, 804 extend into the opening 412, allowing free passage of the ingredients 104 into the mixer 102 while inhibiting the dust cloud 124′ from escaping through the opening 412 and out of the mixer 102.

Another feature of the dust control lid 100 is that the wedge-shaped end 204 defines a cavity 214 that, along with at least one baffle 210, 212, aids in directing the air flow 216 inside the mixer 102. In this way the ingredients 104 inside the mixer 102 will tend to remain inside the mixer 102 and not escape through the opening 412.

Yet another feature of the dust control lid 100 is that the attachment flange 522 that mates with the top rim 120 of the mixer 102 adds additional rigidity to the walls 114 of the mixer 102 such that the ingredients 104 are uniformly mixed throughout.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for reducing a dust cloud expelled from a container when receiving a stream of granular material, the container having a container sidewall with a container opening defined by a rim of the container, said apparatus comprising:
a first end section having a first top plate and a first sidewall, said first end section having a first distal end and first proximal end, said first sidewall having a first upper edge engaging a first edge of said first top plate, said first sidewall extending around said first distal end between each side of said first proximal end, said first sidewall having a first lower edge that is a first attachment member configured to attach to the rim of the container;
a second end section having a second top plate and a second sidewall, said second end section having a second distal end and a second proximal end, said second sidewall having a second upper edge engaging a second edge of said second top plate, said second sidewall extending around said second distal end between each side of said second proximal end, said second sidewall having a second lower edge that is a second attachment member configured to attach to an opposing side of the rim of the container;
a through-opening having a first set of opposing sides defined by said first proximal end of said first end section and said second proximal end of said second end section whereby said first proximal end is spaced apart from said second proximal end;
a first cavity defined by said first top plate and said first sidewall;
a first baffle extending from said first top plate into said first cavity, said first baffle being substantially perpendicular to a longitudinal axis of said first end section and said second end section when configured to install on the container;
a second cavity defined by said second top plate and said second sidewall; and
a second baffle extending from said second top plate into said second cavity, said second baffle being substantially perpendicular to said longitudinal axis.

2. The apparatus of claim 1 wherein said first baffle has a first distal edge extending no further than said first lower edge of said first sidewall of said first end section, and said second baffle has a second distal edge extending no further than said second lower edge of said second sidewall of said second end section.

3. The apparatus of claim 1 further including a third baffle and a fourth baffle, said third baffle extending from said first top plate of said first end section, said third baffle being substantially perpendicular to said longitudinal axis, said fourth baffle extending from said second top plate of said second end section, and said fourth baffle being substantially perpendicular to said longitudinal axis.

4. The apparatus of claim 1 further including a first side member extending between said first and second end sections and a second side member extending between said first and second end sections, said first and second side members defining a second set of opposing sides of said through-opening that provides passage into the container when said first and second end sections are engaging the container.

5. The apparatus of claim 4 wherein said first and second side members each have a top sheet that is positioned to slope downward toward said through-opening.

6. The apparatus of claim 4 further including a first side brush extending from said first side member and a second side brush extending from said second side member, and said first and second side brushes extending into said through-opening.

7. The apparatus of claim 6 wherein said first and second side brushes have an approximate 25 degree angle downward from horizontal.

8. The apparatus of claim 1 further including a first end brush extending from said first proximal end of first end section and a second end brush extending from said second proximal end of said second end section, and said first and second end brushes extending into said through-opening.

9. The apparatus of claim 8 wherein said first and second end brushes have an approximate 25 degree angle downward from horizontal.

10. An apparatus for reducing a dust cloud expelled from a container when receiving a stream of granular material, the container having a container sidewall with a container opening defined by a rim of the container, said apparatus comprising:
a first end section having a distal end and a proximal end, said distal end proximate to an outer wall of the container, said proximal end defining an opening into said container when said first end section engages said container, said first end section having a top plate and a sidewall, said sidewall having a top edge engaging an edge of said top plate, said sidewall extending from said proximal end around said distal end of said end section, said sidewall having a bottom edge configured to engage a portion of a top rim of the container, said top plate and said sidewall defining a cavity with an open bottom; and
a first baffle extending away from a bottom surface of said top plate, said first baffle having a distal edge extending no further than said bottom edge of said sidewall.

11. The apparatus of claim 10 further including a second end section substantially identical to said first end section, said second end section positioned on an opposite side of the container opening when said first end section engages the container.

12. The apparatus of claim 10 wherein said first baffle is positioned approximately midway between said distal end and said proximal end of said first end section.

13. The apparatus of claim 10 further including a second baffle extending away from said bottom surface of said top plate, and said second baffle proximate said proximal end of said first end section.

14. The apparatus of claim 10 further including a first brush extending from said proximal end of said first end section, and said first brush extending away from said first end section.

15. An apparatus for reducing a dust cloud expelled from a container, the container having a container opening configured to receive a stream of granular material, the container having an outer wall with an upper rim defining the container opening, said apparatus comprising:
a first end section having a first top plate and a first sidewall, said first end section having a first distal end and first proximal end, said first sidewall having a first upper edge engaging a first edge of said first top plate, said first sidewall extending around said first distal end between each side of said first proximal end, said first sidewall having a first lower edge that is a first attachment member configured to attach to the rim of the container, and said first end section having a first wedge-shape with said first top plate sloping downward from said first distal end to said first proximal end;
a second end section having a second top plate and a second sidewall, said second end section having a second distal end and a second proximal end, said second sidewall having a second upper edge engaging a second edge of said second top plate, said second sidewall extending around said second distal end between each side of said second proximal end, said second sidewall having a second lower edge that is a second attachment member configured to attach to an opposing side of the rim of the container, and said second end section having a second wedge-shape with said second top plate sloping downward from said second distal end to second first proximal end, said first proximal end of said first end section spaced apart from said second proximal end of said second end section, said first and second proximal ends defining a first pair of opposing sides of a through-opening;
a first cavity defined by said first top plate and said first sidewall; and
a second cavity defined by said second top plate and said second sidewall.

16. The apparatus of claim 15 further including
a first baffle extending from said first top plate of said first end section into said first cavity, said first baffle being substantially perpendicular to a longitudinal axis of said first end section and said second end section when installed on the container; and
a second baffle extending from said second top plate of said second end section into said second cavity, and said second baffle being substantially perpendicular to said longitudinal axis.

17. The apparatus of claim 15 further including a first side brush extending into said through-opening, said first side brush disposed between a first corner of said first proximal end to a corresponding first corner of said second proximal end, and including a second side brush extending into said through-opening, and said second side brush disposed between a second corner of said first proximal end to a corresponding second corner of said second proximal end.

18. The apparatus of claim 17 wherein said first and second side brushes have an approximate 25 degree angle downward from horizontal.

19. The apparatus of claim 15 further including a first end brush extending from said first proximal end and a second end brush extending from said second proximal end; and said first and second end brushes extending into said through-opening.

20. The apparatus of claim 19 wherein said first and second end brushes have an approximate 25 degree angle downward from horizontal.
